(19) United States
(12) Patent Application Publication
(10) Pub. No.: US 2006/0048226 A1
(43) Pub. Date: Mar. 2, 2006

(54) Dynamic security policy enforcement

(76) Inventors: Maarten E. Rits, Sophia Antipolis (FR); Cedric S.P. Ulmer, Nice (FR); Cedric R.J. Hebert, Mouans-Sartoux (FR); Laurent Y. Gomez, Le Cannet (FR); Pascal T.C. Spadone, Antibes (FR)

Correspondence Address: PERKINS COIE LLP, P.O. BOX 2168, MENLO PARK, CA, 94026, US

(21) Appl. No.: 10/932,213

(22) Filed: Aug. 31, 2004

(51) Int. Cl. G06F 11/00; G06F 12/14

(52) U.S. Cl. 726/22

(57) ABSTRACT

A method for dynamic security enforcement includes running an application with linked aspects and determining if a security issue is present in the application. A type of the security issue is determined and an aspect is written to fix the security issue based on the type of the security issue. Finally, the aspect linked to the application.

### FIELD OF THE INVENTION

The present invention relates to software security and more particularly to real-time software security updates.

### BACKGROUND OF THE INVENTION

Application access security policies are typically enforced utilizing an “application manager approach.” That is, the application manager is invoked at specific, security sensitive places in an application. An example of this can take the form of a set of libraries for accessing protected system resources (e.g. a file system or a network connection). A security manager is polled to see if the user has the appropriate permissions. If they do, access is granted. This type of approach has limited flexibility in that security aspects can only be enforced if an invocation is seen in advance. In other words, if a security aspect is not put in place beforehand then that overlooked security aspect is a hole in the security policy. Another issue with the application manager approach is that the type of data can not be modified. An example of this is would be a type of encryption.

To further illustrate, FIG. 1 shows a prior art block diagram illustrating a security policy hierarchy 10. Included in security policy hierarchy 10 is a master security policy 20, sub-organization policies 30, 40 and 50, sub-application policies 60, 70 and 80, an application policy 90 and an associate application 100—collectively designated as an application policy enforcement 110. Security settings made in master security policy 20 affects all policies below it while a specific security policy setting change in sub-organization policy 30 has no effect on sub-organization policies 40 and 50. When a specific instance of application 100 is invoked, application policy 90 based on sub-application policy 60 governs the security settings for application 100.

As previously indicated, this type of hierarchy is not flexible in addressing new security requirements while maintaining the state of the application 100. Typically, the application instance needs to be ended before the new security requirement can be addressed. After the new security setting is set up, the application 100 can be restarted.

To further illustrate how hierarchy 10 relates to a typical network, FIG. 2 shows a prior art block diagram illustrating a server-client architecture 120. Included in architecture 120 is a set of servers 130 and 140 and client computers 150 and 160. Servers 130 and 140 bi-directionally communicate with clients 150 and 160 via network link 170. When client 150 requests an instance of application 100 of FIG. 1, security is governed by application policy 90. Application policy can be defined by any combination of policies 60, 30 and 20.

One prior art attempt at resolving this situation is to employ load-time aspect oriented programming (“AOP”). Aspect oriented programming involves weaving aspects into various points of an application. These aspects can then be utilized to modify an application at those specific points. Load-time aspect oriented programming makes changes to an application when the application is initialized. An example of an aspect-linked application is shown in FIG. 3. FIG. 3 is a prior art block diagram illustrating an aspect-linked application 180. Aspects 190 are attached at key points to application 180 via links 200. If a change in security is necessary, an aspect 190 can be manipulated to execute the change. The change then takes affect when an instance of application 180 is initiated. While load-time AOP perhaps makes it easier to implement new security protocols, it is not capable of implementing changes without stopping the application 180.

As a result of the above situation, there is a need for methods and systems to dynamically effect updates to security while an application is still running.

### SUMMARY OF THE INVENTION

The present invention is described and illustrated in conjunction with systems, apparatuses and methods of varying scope. In addition to the aspects of the present invention described in this summary, further aspects of the invention will become apparent by reference to the drawings and by reading the detailed description that follows.

A method for dynamic security enforcement, in accordance with an embodiment of the present invention, includes running an application with linked aspects and determining if a security issue is present in the application. A type of the security issue is determined and an aspect is written to fix the security issue based on the type of the security issue. Finally, the aspect linked to the application.

A method for dynamic security enforcement, in accordance with another embodiment of the present invention, includes developing security parameters and developing an application. The application is then compiled, utilizing an aspect-oriented programming enabled compiler and ran with linked aspects. It is then determined if a security issue is present in the application. If a security issue exists, then a type of the security issue is determined. An aspect is written to fix the security issue based on the type of the security issue and the aspect is linked to the application.

A system for dynamic security enforcement, in accordance with a final embodiment of the present invention, includes an application with linked aspects and a security policy that determines access to the application. Also included is a dynamic security patch aspect engine capable of detecting a security issue, determining a type of the security issue and modifying the security policy to address the security issue, wherein modifying the security policy is based on the type of the security issue.

Embodiments of the invention presented are exemplary and illustrative in nature, rather than restrictive. The scope of the invention is determined by the appended claims.

### BRIEF DESCRIPTION OF THE DRAWINGS

FIG. 1 is a prior art block diagram illustrating a security policy hierarchy;

FIG. 2 is a prior art block diagram illustrating a server-client architecture;

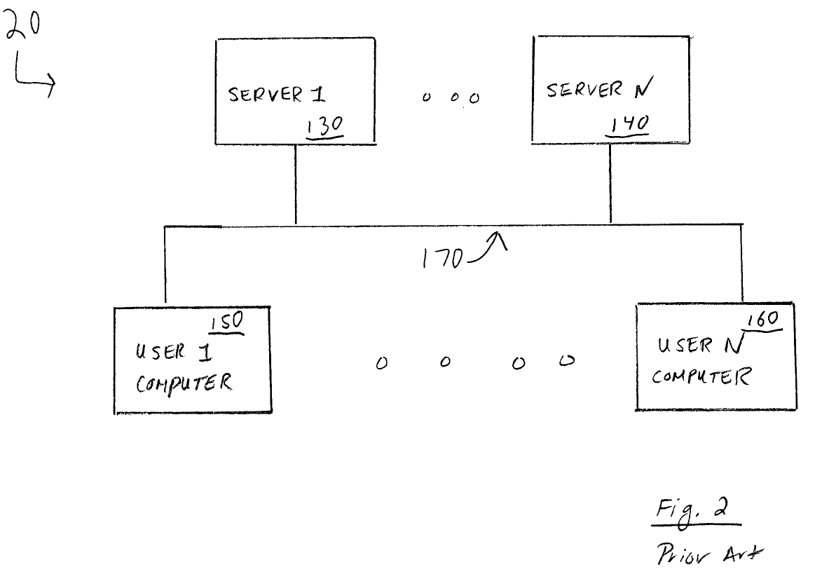

FIG. 3 is a prior art block diagram illustrating an aspect-linked application;

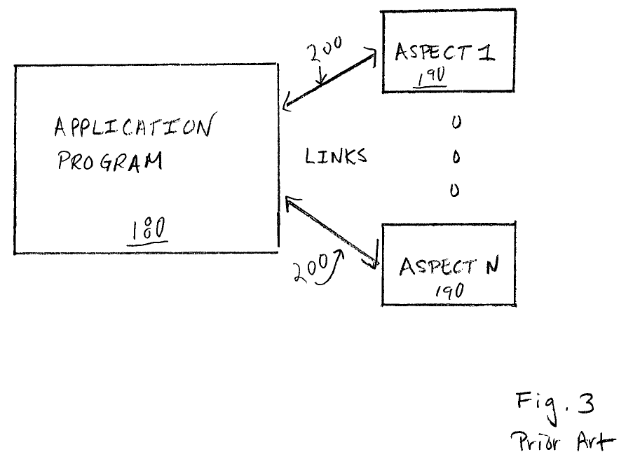

FIG. 4 is a block diagram illustrating how dynamic AOP patches a security update to an application, in accordance with the present invention;

FIG. 5 is a flowchart illustrating a process for applying an aspect security patch to an application, in accordance with the present invention;

FIG. 6 illustrates an example situation that requires a security update, in accordance with the present invention;

FIG. 7 illustrates pseudo-code for addressing the example situation of FIG. 6, in accordance with the present invention;

FIG. 8 illustrates pseudo-code of an aspect security patch, in accordance with the present invention;

FIG. 9 is a block diagram of an embodiment of a network; and

FIG. 10 is a block diagram of an embodiment of a computer.

### DETAILED DESCRIPTION OF THE INVENTION

The present invention contemplates a variety of methods and systems for providing dynamic security policy enforcement. By utilizing dynamic AOP, changes can be seamlessly made to an application without interruption to the application itself. With the dynamic approach, byte-code can be modified during the execution of an application. At every method invocation, variable instantiation and object creation, a check is performed to see if the current byte-code should be changed. As a result of this check, it is possible to specify higher-level security requirements in a security policy. The policy can then be modified to specify where, when and how the policy is enforced. It is additionally possible to add encryption to a cross-platform dataflow during execution of an application. This may need to be done if, for example, the network link was previously considered to be safe. To accomplish this, the policy is specified such that, after a variable instantiation of the dataflow, new byte-code needs to be specified to generate a key generation.

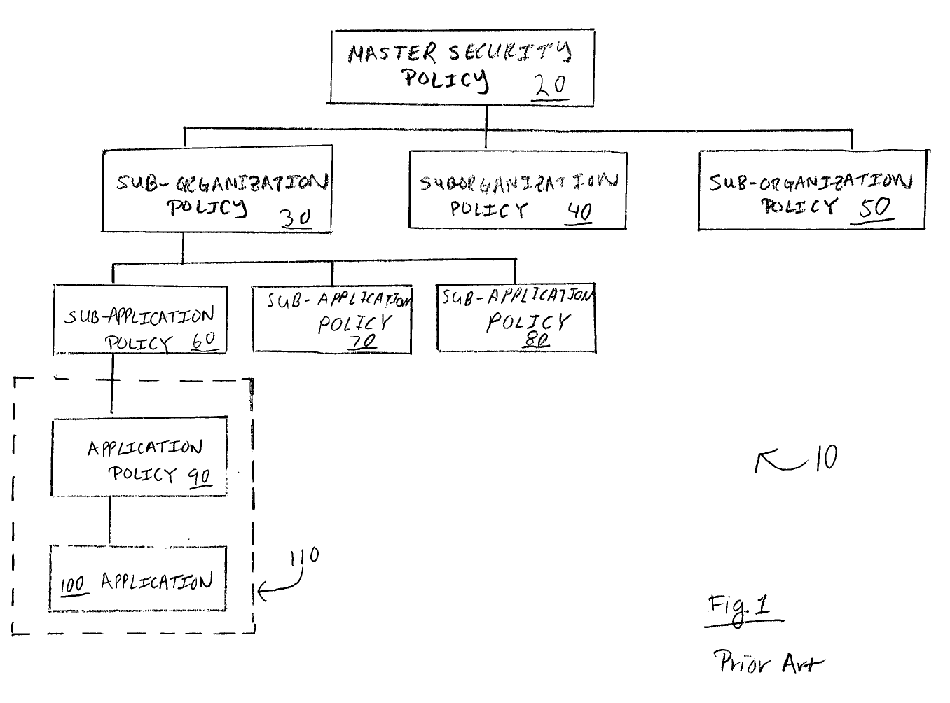

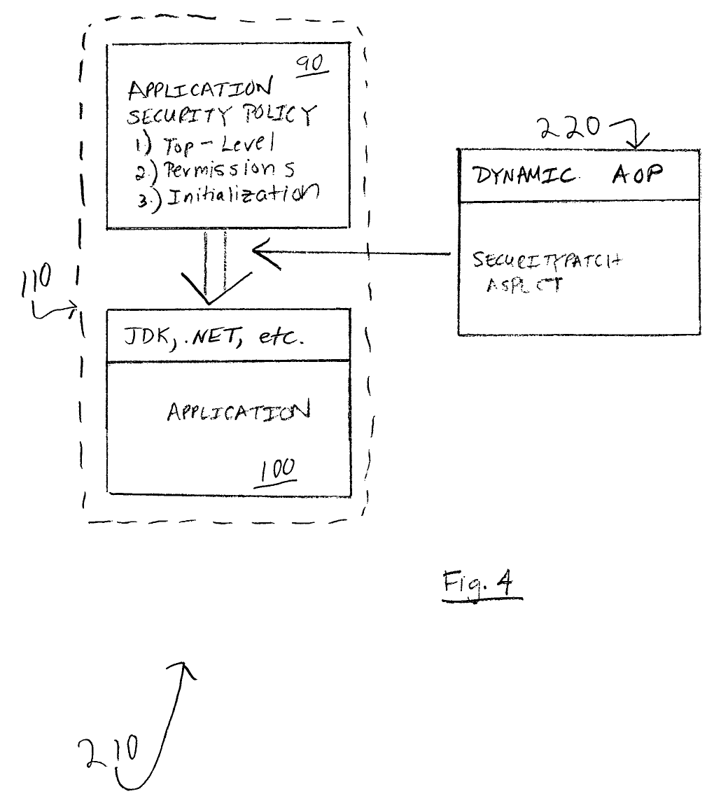

To further describe how dynamic AOP can be used to affect security updates, application policy enforcement 110 of FIG. 1 will now be further detailed with reference to FIG. 4. FIG. 4 is a block diagram 210 illustrating how dynamic AOP patches a security update 220 to an application, in accordance with the present invention. Application policy 90 includes several components. These components are top-level security requirements, permissions and initialization. Top level security typically involves access control, authentication, authorization, confidentiality and integrity. Authentication is used to determine a user's identity while authorization determines the actions available to a user. Permissions include specific attributes of authentications. Integrity relates to the authenticity of a message or data transmission. Initializations relate to encryption and include key length and provider.

Application 100 can be implemented on any number of platforms such as Sun Microsystems' “JDK” or Microsoft's “.NET”. While application 100 is running, its security settings are determined by application policy 90. If a change is required to a security setting, a dynamic AOP security patch aspect 220 is generated and applied to application policy enforcement 110. As previously stated, application 100 maintains its state while security patch 220 is applied. The method of applying patch 220 will now be detailed.

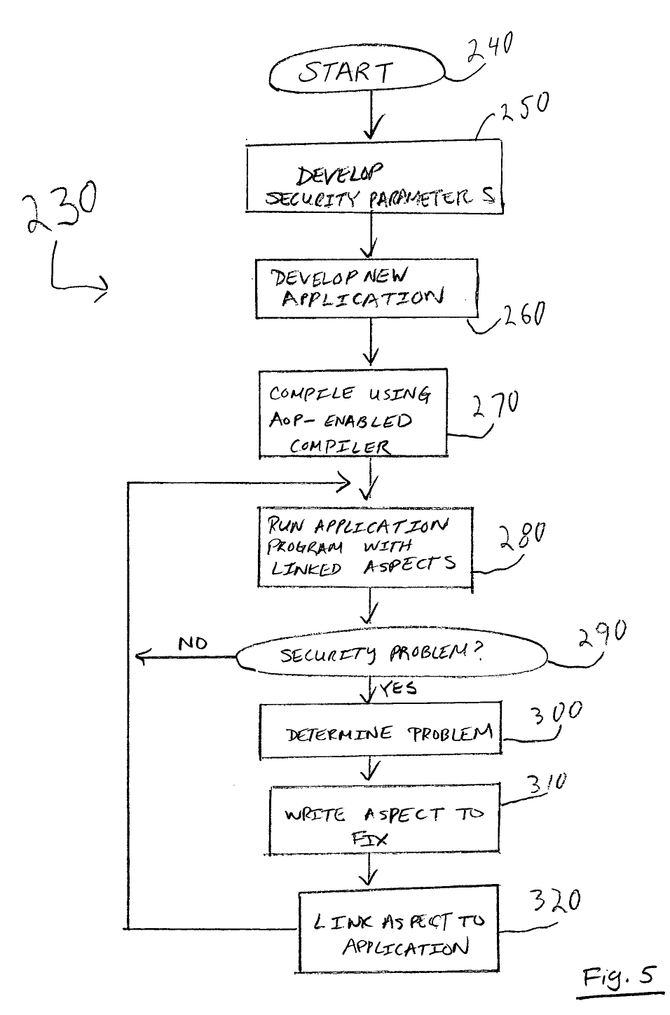

FIG. 5 is a flowchart illustrating a process 230 for applying an aspect security patch to an application, in accordance with the present invention. After a start operation 240, a set of security parameters and a new application are developed at operations 250 and 260. The application is then compiled using an AOP-enabled compiler at operation 270. By using an AOP-enabled compiler, aspects are weaved into key points in the application. These aspects can later be utilized to update the application.

After the application is compiled, the application that now includes linked aspects is initiated at operation 280. Monitoring then begins for a presence of a security problem at decision point 290. If no problem is detected, the application continues to function in its current state. If a problem is detected, control passes to operation 300 where a type of the detected issue is determined and an aspect is generated to address the detected issue, at operation 310. The aspect is based on the type of the security problem. After the aspect is generated, it is linked to the application, at operation 320, thus completing the security update. As previously stated, the patch is administered such that the application is not interrupted. After the patch is administered, the application continues to run at operation 280 and is monitored for any new security problems at operation 290. In some embodiments of the present invention, a security patch aspect engine can be utilized to detect the security, generate an appropriate security patch and link it to the application.

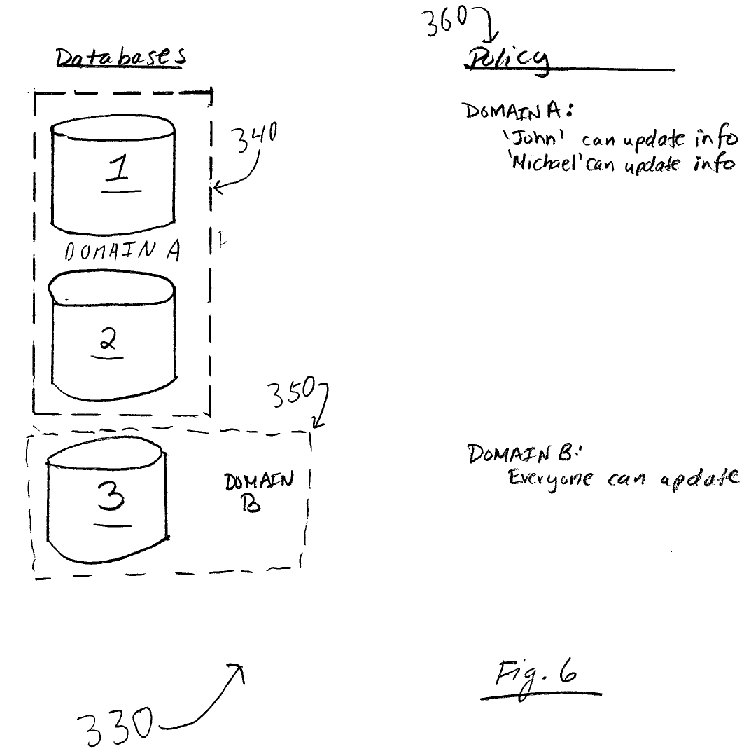

A specific example of a security oversight will now be discussed. FIG. 6 illustrates an example situation 330 that requires a security update, in accordance with the present invention. Included in situation 330 are two domains—domain A 340 and domain B 350. Domain A 340 includes databases 1 and 2 while domain B 350 contains database 3. Also included in example situation is a security policy 360 set such that users John and Michael can access domain A 340 and all users can access domain B 350. However, domain B 350 should not be accessible by all users. Therefore, it is desired to update security policy 360 such that domain B 350 is not accessible to all users.

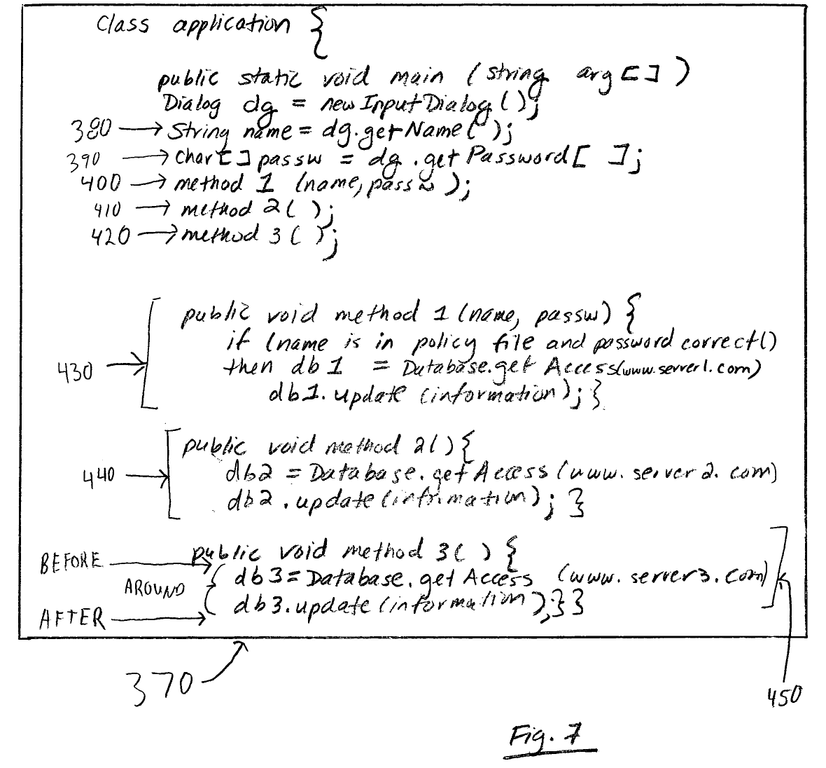

FIG. 7 illustrates pseudo-code 370 of an application for addressing the example situation 330 of FIG. 6, in accordance with the present invention. Included in pseudo-code 370 are various statements such as a username request 380, password request and subroutine calls 400, 410 and 420. If statement 400 is called, section 430 is executed. If statement 410 is called, then section 440 is executed. Similarly statement 420 calls section 450

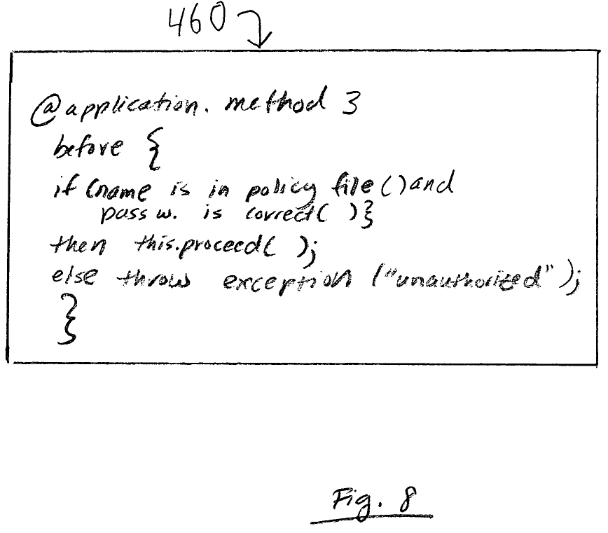

Pseudo-code 370 has already been patched to address situation 330 in that statements 420 and section 450 have been added to pseudo-code 370. Section 450 calls a security patch named “method 3”. This patch defines the security for database 3 and will now be further detailed with reference to FIG. 8.

FIG. 8 illustrates pseudo-code 460 of an aspect security patch, in accordance with the present invention. As previously mentioned, this security patch has been named ‘method 3’ and was added in to apply security to database 3. If a person enters a username listed in the policy file, access is granted assuming they also entered the correct password. If neither is correct, access is denied.

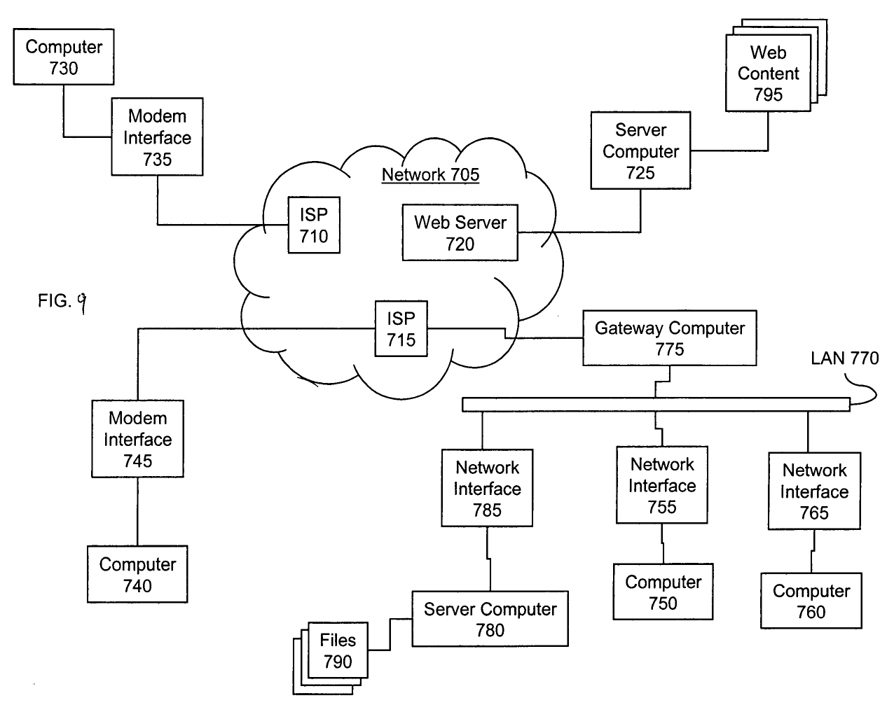

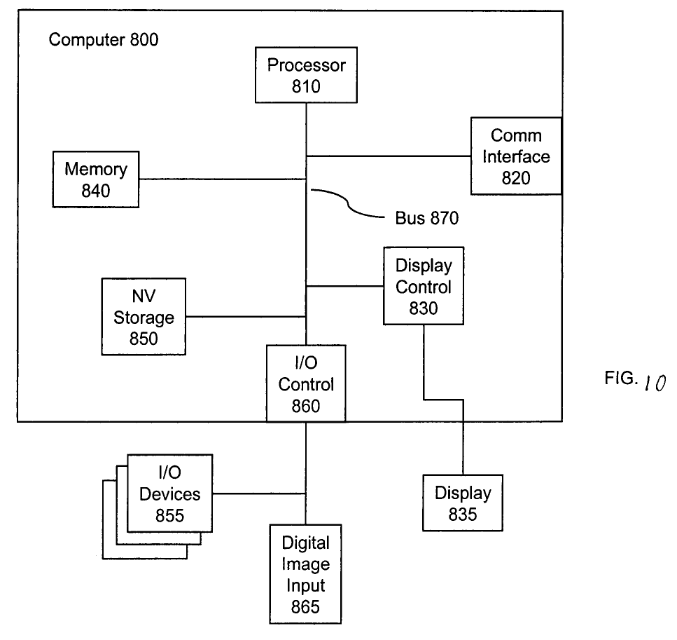

The following description of FIGS. 9-10 is intended to provide an overview of computer hardware and other operating components suitable for performing the methods of the invention described above, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 9 is a block diagram of an embodiment of a network 705, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 705 is typically provided by Internet service providers (ISP), such as the ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send e-mails, and view documents, such as documents which have been prepared in the HTML format. These documents are often provided by web servers, such as web server 720 which is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the World Wide Web and is coupled to the Internet. Optionally, the web server 720 can be part of an ISP which provides access to the Internet for client systems. The web server 720 is shown coupled to the server computer system 725 which itself is coupled to web content 795, which can be considered a form of a media database. While two computer systems 720 and 725 are shown in FIG. 9, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 which can be considered part of the client computer system 730. The client computer system can be a personal computer system, a network computer, a Web TV system, or other such computer system.

Similarly, the ISP 715 provides Internet connectivity for client systems 740, 750, and 760, although as shown in FIG. 9, the connections are not the same for these three computer systems. Client computer system 740 is coupled through a modem interface 745 while client computer systems 750 and 760 are part of a LAN. While FIG. 9 shows the interfaces 735 and 745 as generically as a “modem,” each of these interfaces can be an analog modem, ISDN modem, cable modem, satellite transmission interface (e.g. “Direct PC”), or other interfaces for coupling a computer system to other computer systems.

Client computer systems 750 and 760 are coupled to a LAN 770 through network interfaces 755 and 765, which can be Ethernet network or other network interfaces. The LAN 770 is also coupled to a gateway computer system 775 that can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 10 is a block diagram of an embodiment of a computer that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, ISDN modem, cable modem, token ring interface, satellite transmission interface (e.g. “Direct PC”), or other interfaces for coupling a computer system to other computer systems.

The computer system 800 includes a processor 810, which can be a conventional microprocessor such as an Intel Pentium microprocessor or Motorola Power PC microprocessor. Memory 840 is coupled to the processor 810 by a bus 870. Memory 840 can be dynamic random access memory (DRAM) and can also include static RAM (SRAM). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well-known technology. A digital image input device 865 can be a digital camera which is coupled to an I/O controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to this embodiment, but it may lack some of the features shown in FIG. 9, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the LINUX operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments also relate to apparatus for performing the operations herein. This apparatus may be specially constructed for the required purposes, or it may comprise a general-purpose computer selectively activated or reconfigured by a computer program stored in the computer. Such a computer program may be stored (embodied) in a computer (machine) readable storage medium, such as, but is not limited to, any type of disk including floppy disks, optical disks, CD-ROMs, and magnetic-optical disks, read-only memories (ROMs), random access memories (RAMs), EPROMs, EEPROMS, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

This invention potentially allows for dynamic security enforcement without making interruptions to a run-state of an application. Advantageously, expensive downtime can be avoided to implement security updates.

While this invention has been described in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention.

What is claimed is:

1. A method for dynamic security enforcement comprising:
running an application with linked aspects;
determining if a security issue is present in the application;
determining a type of the security issue;
writing an aspect to fix the security issue based on the type of the security issue; and
linking the aspect to the application.

2. The method as recited in claim 1 wherein the application is continuously monitored for a new security issue and the new security issue is addressed by determining the type of the new security issue, writing a new aspect to fix the new security issue based on a type of the new security issue and linking the new aspect to the application.

3. The method as recited in claim 1 wherein the type of security issue is a top-level security issue.

4. The method as recited in claim 3 wherein the top-level security issue is an authentication security issue.

5. The method as recited in claim 3 wherein the top-level security issue is an authorization security issue.

6. The method as recited in claim 3 wherein the top-level security issue is an integrity security issue.

7. The method as recited in claim 1 wherein the type of security issue is a permissions security issue.

8. The method as recited in claim 1 wherein the type of security issue is an initialization security issue.

9. The method as recited in claim 8 wherein the initialization security issue is a key-length security issue.

10. The method as recited in claim 8 wherein the initialization security issue is a provider security issue.

11. A method for dynamic security enforcement comprising:
developing security parameters;
developing an application;
compiling the application utilizing an aspect-oriented programming enabled compiler;
running the application with linked aspects;
determining if a security issue is present in the application;
determining a type of the security issue;
writing an aspect to fix the security issue based on the type of the security issue; and
linking the aspect to the application.

12. The method as recited in claim 11 wherein the application is continuously monitored for a new security issue and the new security issue is addressed by determining a type of the new security issue, writing a new aspect to fix the new security issue based on the type of the new security issue and linking the new aspect to the application.

13. The method as recited in claim 11 wherein the type of security issue is a top-level security issue.

14. The method as recited in claim 13 wherein the top-level security issue is an authentication security issue.

15. The method as recited in claim 13 wherein the top-level security issue is an authorization security issue.

16. The method as recited in claim 13 wherein the top-level security issue is an integrity security issue.

17. The method as recited in claim 11 wherein the type of security issue is a permissions security issue.

18. The method as recited in claim 11 wherein the type of security issue is an initialization security issue.

19. The method as recited in claim 18 wherein the initialization security issue is a key-length security issue.

20. The method as recited in claim 18 wherein the initialization security issue is a provider security issue.

21. A system for dynamic security enforcement comprising:
an application with linked aspects;
a security policy that determines access to the application;
a dynamic security patch aspect engine capable of detecting a security issue, determining a type of the security issue and modifying the security policy to address the security issue, wherein modifying the security policy is based on the type of the security issue.

22. The system as recited in claim 21 wherein the dynamic security patch aspect engine modifies the security policy by writing and linking an aspect to the application.

23. The system as recited in claim 21 wherein the dynamic security patch aspect engine continuously monitors the application for a new security issue and addresses the new security issue by determining a type of the new security issue and modifying the security policy to address the security issue, wherein modifying the security policy is based on the type of the new security issue.

24. The system as recited in claim 23 wherein the dynamic security patch aspect engine modifies the security policy by writing and linking an aspect to the application.

25. The system as recited in claim 21 wherein the type of security issue is a top-level security issue.

26. The system as recited in claim 25 wherein the top-level security issue is an authentication security issue.

27. The system as recited in claim 25 wherein the top-level security issue is an authorization security issue.

28. The system as recited in claim 25 wherein the top-level security issue is an integrity security issue.

29. The system as recited in claim 21 wherein the type of security issue is a permissions security issue.

30. The system as recited in claim 21 wherein the type of security issue is an initialization security issue.

31. The system as recited in claim 30 wherein the initialization security issue is a key-length security issue.

32. The method as recited in claim 30 wherein the initialization security issue is a provider security issue.

33. A data structure for dynamic security policy enforcement that utilizes a dynamic aspect-oriented security patch for performing a security update to an application.
